(19) United States
(12) Patent Application Publication
(10) Pub. No.: US 2025/0278577 A1
(43) Pub. Date: Sep. 4, 2025

(54) SYSTEMS AND METHODS FOR COORDINATING ADVANCED COMMUNICATIONS AND DELIVERY SYSTEMS

(71) Applicant: State Farm Mutual Automobile Insurance Company, Bloomington, IL (US)

(72) Inventors: Edward W. Breitweiser, Bloomington, IL (US); Jennifer L. Crawford, Normal, IL (US); Ryan K. Mathews, New Albany, OH (US); Kenny Haggard, Bloomington, IL (US); Ashley Peters, Cottage Grove, MN (US)

(21) Appl. No.: 18/954,213

(22) Filed: Nov. 20, 2024

Related U.S. Application Data
(60) Provisional application No. 63/559,567, filed on Feb. 29, 2024.

(51) Int. Cl. G06F 40/40

(52) U.S. Cl. CPC G06F 40/40

(57) ABSTRACT

A computer system for coordinating advanced language communications is provided. The system including at least one processor in communication with at least one memory device. The at least one processor programmed to: a) receive a request for information about a first individual; b) retrieve information from one or more data sources based upon the request for information; c) determine one or more missing items of information based upon the retrieved information and the request for information; d) execute a GPT model trained with interaction data to generate one or more questions for the first individual to answer in order to provide the one of missing items of information; and e) present the one or more questions to the first individual.

### CROSS-REFERENCE TO RELATED APPLICATIONS

This application claims the benefit of priority of U.S. Provisional Patent Application No. 63/559,567, filed Feb. 29, 2024, and entitled “SYSTEMS AND METHODS FOR COORDINATING ADVANCED COMMUNICATIONS AND DELIVERY SYSTEMS,” the contents and disclosures of which are hereby incorporated herein by reference in their entirety.

### FIELD OF THE DISCLOSURE

The present disclosure relates to coordinating advanced communications and delivery systems, and more particularly, to a network-based system and method for using artificial intelligence tools to analyze past communications to determine optimal communications and delivery systems of the communications with individual users.

### BACKGROUND

It may be very important to extract the right and correct information from customers to properly service their needs. In many cases, this information extraction may be performed by using a simple application form that is provided to the customer or an interview conducted with the customer over the phone. Furthermore, each customer may be different with their own preferences, manner of speaking, and dialect.

Chatbots may be used, for example, to answer questions, obtain information from, and/or process requests from a user or customer. In many cases, these chatbots may be used to handle phone calls from callers or customers. In some of these cases, interacting with a chatbot may be irritating to the callers. Callers may feel like they must repeat themselves to be understood, or they may be placed in a loop of responses which may make them feel like they are not getting where they need to be within the system. This may lead to a point where the caller continues to repeat themselves and they quickly want to talk to a real person, which defeats the purpose of having the chatbot.

In many cases, a live representative that handles customer support or is otherwise responsible for other customer interactions may have to look-up certain information to determine which information is missing and/or needed from a caller. In taking time to look for the missing information associated with the caller's reason for calling may make the representative look unknowledgeable or rude for not paying attention to the call. Additionally, the representative may have to put the caller on hold to look up or find the relevant or missing information. Conventional techniques may have other efficiencies, encumbrances, ineffectiveness, and/or drawbacks as well.

### BRIEF SUMMARY

The present embodiments may relate to, inter alia, coordinating advanced communications and delivery systems with an individual, and more particularly, to a network-based system and method for using artificial intelligence tools to analyze past communications to determine optimal communications and delivery system with individual users. The systems and methods may be configured to retrieve truthful and accurate information from individuals via textual, audible, or other communications. The systems and methods described herein may provide for analyzing a plurality of previous user interactions to determine user preferences including preferred communication channels and techniques for communicating with each individual user.

In one aspect, a computer system configured to utilize artificial intelligence tools to analyze customer communications and/or information, and/or determine optimal communications with a customer may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chatbots, ChatGPT bots, and/or other electronic or electrical components, which may be in wired or wireless communication with one another. For instance, the computer system may include a computing device that may include at least one processor in communication with at least one memory device. The at least one processor may be configured to: (1) receive a request for information about a first individual; (2) retrieve information from one or more data sources based upon the request for information; (3) determine one or more missing items of information based upon the retrieved information and the request for information; (4) execute a GPT model trained with interaction data to generate one or more questions for the first individual to answer in order to provide the one of missing items of information; and/or (5) present the one or more questions to the first individual. The computer system may include additional, less, or alternate functionality, including that discussed elsewhere herein.

In another aspect, a computer-implemented method may be provided. The computer-implemented method may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chatbots, ChatGPT bots, and/or other electronic or electrical components, which may be in wired or wireless communication with one another. For example, the computer-implemented method may be performed by a computer device including at least one processor in communication with at least one memory device. The method may include: (1) receiving a request for information about a first individual; (2) retrieving information from one or more data sources based upon the request for information; (3) determining one or more missing items of information based upon the retrieved information and the request for information; (4) executing a GPT model trained with interaction data to generate one or more questions for the first individual to answer in order to provide the one of missing items of information; and/or (5) presenting the one or more questions to the first individual. The computer-implemented method may include additional, less, or alternate actions, including those discussed elsewhere herein.

In another aspect, at least one non-transitory computer-readable media having computer-executable instructions embodied thereon may be provided. The computer-executable instructions may be executed by one or more local or remote processors, servers, sensors, memory units, transceivers, mobile devices, wearables, smart watches, smart glasses or contacts, augmented reality glasses, virtual reality headsets, mixed or extended reality headsets, voice bots, chatbots, ChatGPT bots, and/or other electronic or electrical components, which may be in wired or wireless communication with one another. When executed by a computing device including at least one processor in communication with at least one memory device, the computer-executable instructions may cause the at least one processor to: (1) receive a request for information about a first individual; (2) retrieve information from one or more data sources based upon the request for information; (3) determine one or more missing items of information based upon the retrieved information and the request for information; (4) execute a GPT model trained with interaction data to generate one or more questions for the first individual to answer in order to provide the one of missing items of information; and/or (5) present the one or more questions to the first individual. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a block diagram of an exemplary conversation management system for analyzing past communications to determine effective and/or optimal communication methods with individual users, in accordance with at least one embodiment.

FIG. 2 illustrates an exemplary computer implemented process for analyzing past communications to determine effective and/or optimal communication methods with individual users using the system shown in FIG. 1.

FIG. 3 illustrates an exemplary computer system for performing the processes shown in FIG. 2.

FIG. 4 is a schematic diagram of an exemplary conversation analysis (CA) server shown in FIG. 1, that may be used with the systems shown in FIGS. 1 and 3.

FIG. 5 illustrates an exemplary configuration of a user computer device, in accordance with one embodiment of the present disclosure.

FIG. 6 illustrates an exemplary configuration of a server computer device, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, a network-based system and method for coordinating advanced communications and delivery systems, and more particularly, to a network-based system and method for using artificial intelligence tools to analyze past communications to determine effective and/or optimal communication methods and communication delivery systems for a particular individual user. In one exemplary embodiment, the process may be performed by a conversation analysis (CA) computer device.

In the exemplary embodiment, the CA computer device may be in communication with one or more user devices, one or more analysis models, one or more internal data sources, and/or one or more external data sources. As described below in further detail, the CA computer device may include one or more large language models (LLM), such as GPT (Generative Pre-trained Transformers) models, and one or more supplemental models that are configured to curate data from internal and external sources to send to the one or more GPT models. The one or more supplemental models are configured to leverage the one or more GPT models for their wide range of capabilities. In some embodiments, the systems and methods described herein may also use behavioral models and/or economic models in addition to models based upon conversations.

At least one goal of the systems and methods described herein is to determine the best way (e.g., most effective or optimal delivery system for receiving requested information and/or most effective or optimal wording of the request) to have a conversation with an individual to obtain information from the individual, based on what is known about the person. This includes what type of language does the individual involved in the conversation prefer to use (e.g., formal language versus casual language). This may be learned from a plurality of interactions, such as, but not limited to, call center interactions and conversations with agents (both human and chatbot) and the individual. These interactions may include verbal conversations, such as over a phone call or a computer audio call, as well as texted based interactions, including, but not limited to, text communications, instant messages, emails, online forms, and/or other textual communications. These interactions are used to help train the models that are then used to output recommendations for that user and other users.

In the exemplary embodiment, the CA computer device creates and/or recommends an optimal language for interaction scripts using LLMs. The interaction scripts may be generated by the system for either a live person or chatbot to then use when interacting with the user or individual. This optimal language for interaction may include the CA computer device identifying the optimal way to phrase a question to receive a desired and/or accurate response, for example, evaluating one or more scripts to determine which have been most successful in the past, thereby increasing the likelihood a customer will complete an application, etc. This may also include the CA computer device analyzing known customer information, determining what the enterprise GPT LLMs do not know about the customer, identifying risk factors that are unknown about the customer, and/or identifying the most efficient method to gather information from the customer. This may include having the CA computer device identify the optimal way to phrase a question to receive a desired and/or accurate response, evaluate one or more scripts to determine which have been most successful based on past results, in order to increase the likelihood a customer will complete an application, or provide necessary information, etc.

In some embodiments, the CA computer device may use GPT LLMs to determine conflicts, inconsistencies (e.g., documents inconsistent with research), and/or contradictions in a contract and/or other document. The CA computer device may also use GPT LLMs to identify the discrepancies between documents, provide explanations for the discrepancies, and/or propose alternate language to address the inconsistencies.

In some embodiments, the CA computer device determines which type of communication channel is the user the most responsive. For example, is user A more responsive to an online form (such as an electronic questionnaire), a text chat conversation, and/or a verbal collection process, such as over the phone or computer call. In these embodiments, the CA computer device determines how user A contacts the company, the service, or the website. For example, user A may have only used in the past instant messages and a chat interface, but not the phone or verbal interactions. In this case, the CA system may identify instant messaging as the preferred channel of communication for the user.

In some embodiments, the CA computer device also determines an ordering for questions to achieve the best response results, based upon past interactions with the individual and interactions with other individuals. For example, are the achieved results better if Question A is asked before or after Question B? How many questions should be asked between Questions A and B?

In further embodiments, the CA computer device may determine how many questions to ask the individual during an interaction or session. For example, the CA computer device may generate an online questionnaire for the individual that has all or only a portion of the questions that need to be answered. The CA computer device may also create multiple online questionnaires that each include a portion of the questions that need to be answered. This may be useful where the individual is known to have a low attention span and will not fill out a lengthy questionnaire.

The CA computer device may determine the amount of time that the individual will spend on a questionnaire and builds multiple questionnaires to send to the individual over a period of time. The CA computer device may put the important questions in the first one or two questionnaires and less important questions in later questionnaires. The CA computer device may then transmit links to the next questionnaire to the individual. In additional embodiments, the CA compute device may ask the questions one at a time over a chat or texts.

In an additional embodiment, the CA computer device may build a script of questions for a user or chatbot to ask the individual. This script may be presented over a user interface, via a telephonic interview, and/or via a chat interface, for example. The script includes the needed questions in a specific order based on what is known about the individual and other individuals similar to the individual in question. In some embodiments, the CA computer device may generate a unique script for the individual in question when the individual is in contact with the company. In other embodiments, the CA computer device generates the unique script for the individual in question and instructs a user and/or chatbot to contact the individual using the preferred channels of communication.

In some embodiments, the system may identify inconsistencies in a document, such as a contract. This system may assist with the creation and review of documents and auditing of documents. For example, the system may monitor for a term in a contract that was upheld (or disputed) in a legal case in a state or terms that are heavily contested in such legal cases. In another example, the system may be used to update the employee manual with the latest case law.

While the systems and methods described herein disclose insurance-based examples, one having skill in the art would understand that these are for example purposes only and that the systems and methods described herein may be used for other implementations in other industries as well.

### Exemplary Intelligent Message Handling System

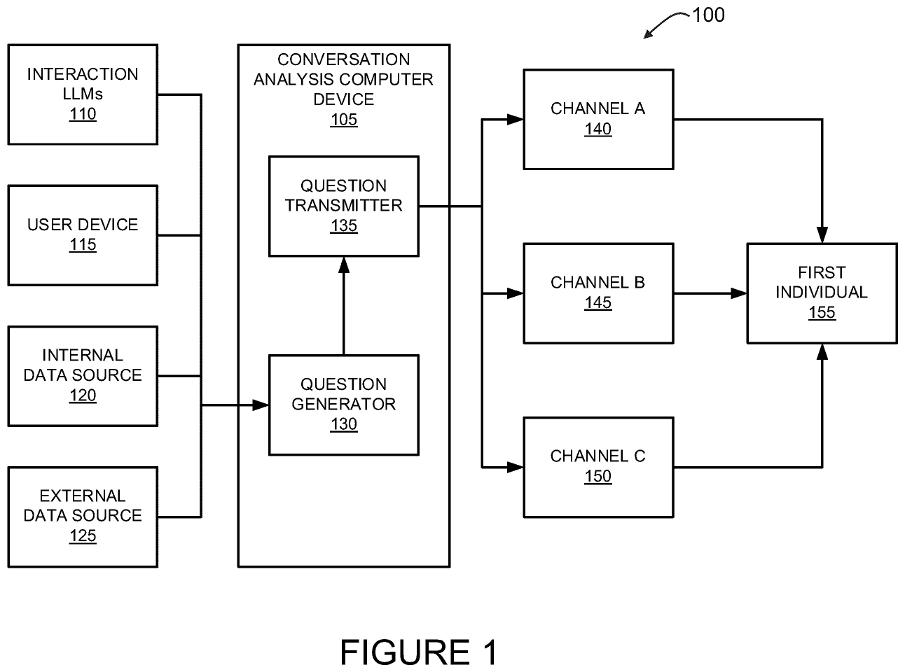

FIG. 1 illustrates a block diagram of an exemplary conversation management system 100 for analyzing past communications to determine effective and/or optimal communication methods with individual users, in accordance with at least one embodiment of the present disclosure. In the exemplary embodiment, the conversation management system 100 is configured to create and/or recommend an optimal language interaction script using large language models (LLMs). The conversation management system 100 may (i) identify the optimal way to phrase a question in order to receive a desired and/or accurate response, (ii) evaluate one or more generated scripts to determine which have been most successful in the past for soliciting responses, and (iii) facilitate an increase in the likelihood a customer will complete an application, questionnaire, form, etc.

The conversation management system 100 may analyze known customer information, determine what the system does not know about the customer, identify risk factors that are unknown about the customer, and/or identify the most efficient method to gather information from the customer based on this analyzed information. The conversation management system 100 may create and/or recommend the optimal language interaction script using the LLMs. The conversation management system 100 uses LLMs to determine conflicts, inconsistencies (e.g., documents inconsistent with research), and/or contradictions in a contract and/or another document. The LLMs may identify the discrepancies, provide explanations for the discrepancies, and/or propose alternate language to address the inconsistencies.

The goal is to generate questions that the first individual 155 will mostly likely answer to allow the system 100 to address and fill the gaps in the information already known about the first individual 155 while still paying attention to customer convenience. At least one goal of the systems and methods described herein is to determine the best way (e.g., most effective delivery system for receiving requested information and/or most effective wording of the request) to have a conversation with the first individual 155 to obtain information from the individual 155, based on what is known about the person. This includes what type of language does the first individual 155 in the conversation prefer (e.g., formal language versus casual language). This may be learned from a plurality of interactions, such as, but not limited to, call center interactions and conversations with agents (both human and chatbot) by the first individual 155. These interactions may include verbal conversations, such as over a phone call or a computer audio call, as well as texted based interactions, including, but not limited to, text communications, instant messages, emails, online forms, and/or other textual communications. These interactions are used to help train the models that are then used to output recommendations for that user and other users.

In the exemplary embodiment, the conversation management system 100 may be configured to coordinate communications with individual participants and/or groups of participants to gather information from those participants and groups of participants based upon a plurality of rules and user preferences. In some embodiments, the conversation management system 100 may be associated with a business that needs to communicate with its customers, such as by providing information to and requesting information from their customers.

In the exemplary embodiment, the conversation management system 100 may include a computer analysis (CA) computer device 105. The CA computer device 105 may be configured to receive requests for information about a participant, individual, and/or user. The CA computer device 105 may be in communication with one or more trained interaction LLMs 110. In at least one embodiment, the large language models 110 may be GPT (Generative Pre-trained Transformers) models.

In the exemplary embodiment, the interaction LLMs 110 may be trained using interaction data between individuals and agents of the company, service, or website. The interactions may include, but are not limited to, text messages, audio calls, video calls, instant messages, emails, chat logs, user interface interactions, virtual/augmented reality interactions, and/or other interactions between the individuals and the agents of the company, service, or website. The interaction LLMs 110 may be trained to determine communication preferences of individuals based upon their past interactions and any stated preferences. The communication preferences may include, but are not limited to, preferred communication channels, preferred accent, preferred dialect, length of attention span for questions, etc. The interaction LLMs 110 are also training to determine methods and manners for asking questions to individuals to improve the likelihood of those individuals answering truthfully and accurately.

The CA computer device 105 may also be in communication with one or more user devices 115. The user devices 115 are computer devices being used by one or more agents of the company, service, or website. For example, a first user device 115 may be associated with an insurance agent setting up an account. A second user device 115 may be associated with an artificial intelligence agent that is has determined that there is a need for other information about a user. A third user device 115 may be associated with an underwriter that needs additional information for a policy. A fourth user device 115 may be associated with a call center representative that is receiving a call from or making a call to a specific individual. A fifth user device 115 may be associated with a chatbot that is communicating with the specific individual, etc.

In the exemplary embodiment, the CA computer device 105 may receive a request for information about the first individual 155 from the user device 115. The request may be for information that would be part of a questionnaire for the first individual 155 to set-up a service for that individual 155. The request may be for information about the first individual 155 to better find out what the first individual's needs from the company, service, or website.

In the exemplary embodiment, the CA computer device 105 may access internal data sources 120 and/or external data sources 125 to determine as much of the requested information as possible. The purpose is to reduce the amount of information that is needed to be requested from the first individual 155 by filling in any missing information that may be found in the internal data sources 120 and/or external data sources 125.

The internal data sources 120 may include data about clients and/or customers, such as PII, personally identifiable information. The internal data sources 120 may also include proprietary information that is private to the company. The external data sources 125 may include publicly available information. The external data sources 125 may also include private information that is being provided by the owners of that information, such as a third-party vendor.

In the exemplary embodiment, the CA computer device 105 may include a question generator module 130 and a question transmitter module 135. After filling in all of the available information about the first individual 155 into the request from the user device 115, the CA computer device 105 determines what information is still needed. The CA computer device 105 may execute the interaction LLMs 110 to determine the optimal communication methods for communicating the questions with the first individual 155. The optimal communication methods may include, but are not limited to, the communication channel to use, how to phrase the questions, which order to ask the questions, how often to ask a question, and/or a plurality of other communication parameters that may increase the likelihood of the first individual 155 accurately and truthfully answering the questions to provide the needed information.

The CA computer device 105 may use the question generator module 130 to generate the questions based upon the output from the interaction LLMs 110. Then the CA computer device 105 may use the question transmitter module 135 to transmit the questions via the appropriate channel, such as channel A 140, channel B 145, and channel C 150. The different channels A 140, B 145, and C 150 may include, but are not limited to, SMS text messages, emails, chat programs, direct messaging programs, automated phone calls, social media programs, provided applications, online forms, and/or any other message channel to allow for communication with the first individual 155.

In some embodiments, different questions may be assigned to different channels, where the first individual 155 receives some questions via channel A 140 and other questions via channel B 145. These questions could be sent in close proximity to each other or at different time periods.

In some further embodiments, the question on channel A 140 may direct the first individual 155 to channel C 150. In these embodiments, the message may include a link, such as a hyperlink, directing the user to a website, such as website form for filling out information. The first individual 155 may then communicate through the website, such as through a chat function or by filling out one or more web-based forms. This may allow the system 100 to pivot between channels for different communications.

### Exemplary Computer-Implemented Method

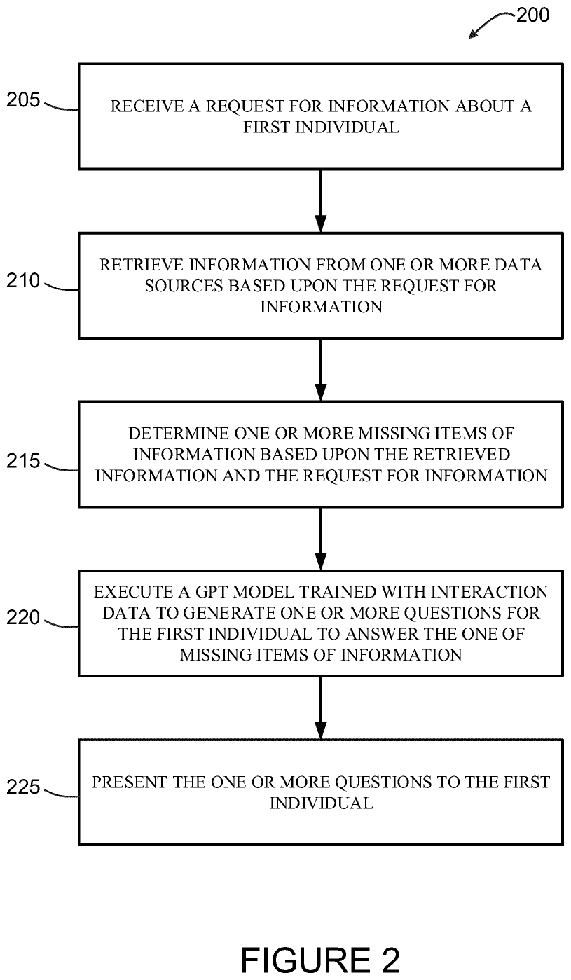

FIG. 2 illustrates a flow chart of an exemplary computer-implemented method 200 for analyzing past communications to determine effective and/or optimal communication methods with individual users using the system 100 (shown in FIG. 1). In the exemplary embodiment, method 200 may be implemented by the CA computer device 105 (shown in FIG. 1).

In the exemplary embodiment, the CA computer device 105 receives 205 a request for information about the first individual 155 (shown in FIG. 1). In some embodiments, the request for information is received from a user device 115 (shown in FIG. 1) associated with an agent of the company, service, or website. In some embodiments, the agent includes, but is not limited to, a call center representative, a customer service employee, a sales representative, a chatbot, a virtual avatar, an underwriter, a claims adjuster, a healthcare provider, and/or any other potential agent.

In the exemplary embodiment, the CA computer device 105 retrieves 210 information from one or more data sources, such as internal data source 120 and external data source 125, based upon the request for information. The CA computer device 105 may access multiple data sources 120 and 125 to find the needed information. In the exemplary embodiment, the CA computer device 105 may determine which data sources 120 and 125 to access to retrieve 210 the needed information.

In some embodiments, the CA computer device 105 prefills the needed information with data from other interactions with the individual 155, policies, public records, and/or other data. This includes any information that is already known about the first individual 155, such as information that the individual 155 already shared in previous interactions. The CA computer device 105 may be able to look up previous interactions that the first individual 155 had with the system 100 and to retrieve some of the information from those previous interactions.

The CA computer device 105 may retrieve 210 data from previous recent applications that the individual 155 made and from social media information that is publicly available. The CA computer device 105 may identify risk factors that are unknown for the individual, such as by looking at the differences in risk factors for the individual including comparing applicants from last year versus those from 25 years ago to identify risk factors that may be applicable to this individual.

In the exemplary embodiment, the CA computer device 105 may determine 215 one or more missing items of information based upon the retrieved information and the request for information. In the exemplary embodiment, the data sources 120 and 125 may not have all of the needed information about the first individual 155 and the CA computer device 105 determines 215 which items of information are still needed. For example, the CA computer device 105 may reduce or remove questions on an application, form, and/or questionnaire to remove those related to already known information.

In the exemplary embodiment, the CA computer device 105 executes 220 a GPT model, such as interaction LLMs 110 (shown in FIG. 1) trained with interaction data to generate one or more questions for the first individual 155 to answer in order to provide the one of missing items of information. The CA computer device 105 and the interaction LLM 110 generate the questions to maximize the likelihood that the first individual 155 will truthfully and accurately answer the questions with the needed information. The goal is to generate questions that the individual 155 will answer to allow for closing the gaps while still paying attention to customer convenience.

The LLMs 110 assist the CA computer device 105 in determining the most efficient way to gather information that is missing, by asking the correct questions, in the correct order, and using the preferred language when asking the questions. The right or preferred language may include the individual's preferred language and/or dialect. The LLMs 110 and the CA computer device 105 coordinate to put the questions in a format and/or channel best suited to the need and most likely to get a response from the individual 155.

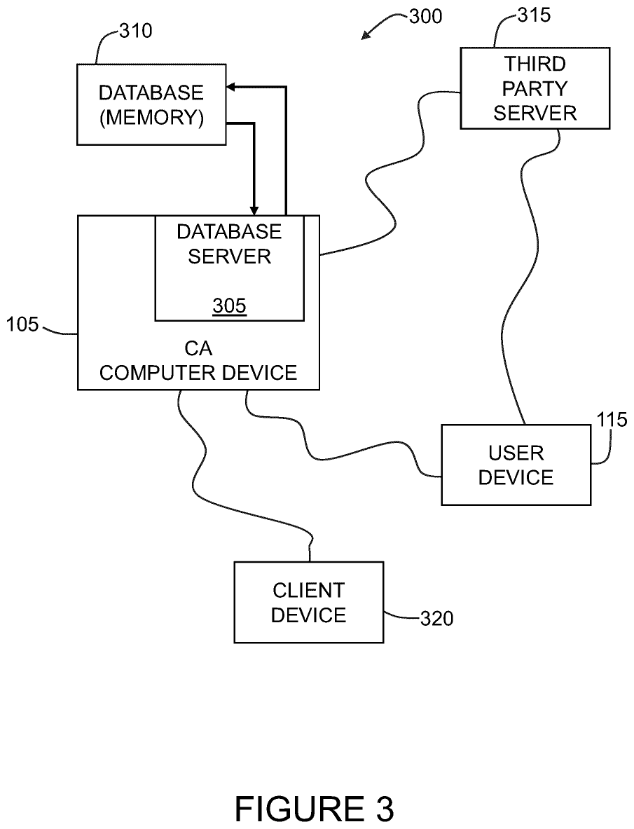

In the exemplary embodiment, the CA computer device 105 presents 225 the one or more questions to the first individual 155 through a computer device associated with the first individual 155, such as client device 320 (shown in FIG. 3).

In some embodiments, the CA computer device 105 receives, from the client device 320 of the first individual 155, one or more responses to the one or more questions. In the exemplary embodiment, the CA computer device 105 communicates with the first individual 155 using one or more channels 140, 145, and 150 determined by the CA computer device 105 and the interaction LLMs 110.

In further embodiments, the CA computer device 105 generates a response to the request for information based upon the retrieved information and the one or more responses to the one or more questions and transmits that response to the user device 115 that the request was received on. In some embodiments, the CA computer device 105 transmits a partial response with the information that was found in the data sources 120 and 125, and then transmits the rest of the information when received from the first individual 155.

In some embodiments, the CA computer device 105 determines a first channel 140, 145, and 150 to transmit the one or more questions to a computer device associated with the first individual 155. The first channel 140, 145, and 150 may be selected to choose the channel 140, 145, and 150 with the highest likelihood of receiving responses from the first individual 155.

In some further embodiments, there may be more than one question that needs to be communicated, such as a first question and a second question. In these embodiments, the CA computer device 105 determines a first channel 140 to transmit the first question to a client device 320 associated with the first individual 155. The CA computer device 105 may determine a second channel 145 to transmit the second question to a client device 320 associated with the first individual 155. In this embodiment, the first channel 140 and the second channel 145 are or may be different. In some embodiments, the two questions are transmitted at separate periods of time, such that the CA computer device 105 transmits the second question a period of time after the first question was answered, even if they were sent on the same channel 140.

In still further embodiments, the CA computer device 105 trains the GPT model 110 with a plurality of interaction data with a plurality of individuals 155 over a plurality of channels 140, 145, and 150. The GPT model 110 may also be trained with a plurality of interaction data associated with the first individual 155. The GPT model 110 is executed with a plurality of interaction data associated with the first individual 155 as input. The LLMs 110 are trained to look at individuals, such as customers and almost customers to determine what information is already gathered and what needs to be requested. The CA computer device 105 may be able to look up previous interactions that the first individual 155 had with the system 100 and to retrieve some of the information from those previous interactions.

In additional embodiments, the CA computer device 105 generates the one or more questions via natural language processing.

In some additional embodiments, the LLMs 110 are in communication with one or more automated call centers. The LLMs 110 gather interaction information from the one or more automated call centers. In these embodiments, the LLMs 110 may use recordings of calls and interactions with individuals 155 for training and retraining purposes.

In further embodiments, the LLMs 110 develop the questions to be asked to each individual 155 so that the questions are customized for the corresponding individual 155. The LLMs 110 may also determine the order for the questions, where the order is also customized for each individual 155.

In still further embodiments, the CA computer device 105 prefills the needed information with data from other interaction with the individual 155, policies, public records, and/or other data. Then the CA computer device 105 reduces any questions on an application, form, and/or questionnaire to remove those related to already known information.

The systems and methods described herein may be used to augment person-to-person interactions. For example, the system 100 may be used in an insurance setting to assist underwriters looking for more information, an agent collecting information and/or an interviewer collecting information. The system may be used to help the agent/interviewer to pick a path or approach for conversing with the individual 155 based upon the information that the system 100 has about that individual 155. For example, if the individual is unsure about something, is there another approach available, or is more information needed?

The system 100 may also assist the agent by adjusting how to talk to an individual 155 based on their interactions, both past and current. For example, if the individual 155 asks what an annuity is, this indicates a need for more explanation of financial terms. The system 100 may suggest that it would be better to use concepts with the individual 155 rather than official terms.

### Exemplary Computer System

FIG. 3 illustrates an exemplary computer system 300 for performing the method 200 (shown in FIG. 2). In the exemplary embodiment, the system 300 may be used for using artificial intelligence tools to analyze past communications to determine effective and/or optimal communication methods and communication delivery systems for a particular individual user.

As described below in more detail, the conversation analysis (CA) computer device 105 may be programmed to use artificial intelligence tools to analyze past communications to determine effective and/or optimal communication methods and communication delivery systems for a particular individual user. In addition, the CA computer device 105 may be programmed to coordinate the communication and execution of large language models (LLM). In some embodiments, the CA computer device 105 may be programmed to (1) receive a request for information about a first individual; (2) retrieve information from one or more data sources based upon the request for information; (3) determine one or more missing items of information based upon the retrieved information and the request for information; (4) execute a GPT model trained with interaction data to generate one or more questions for the first individual to answer in order to provide the one of missing items of information; and/or (5) present the one or more questions to the first individual, such as visually or graphically via a display screen; verbally or audibly via a voice bot or chatbot; or other in other manners.

In the exemplary embodiment, the CA computer device 105 (also known as CA server 105) may be a computer that includes a web browser or a software application, which enables CA computer device 105 to communicate with user devices 115 and client devices 320 using the Internet, a local area network (LAN), or a wide area network (WAN). In some embodiments, the CA computer device 105 may be communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem.

CA computer device 105 may be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chatbots, voice bots, ChatGPT bots or ChatGPT-based bots, or other web-based connectable equipment or mobile devices.

In the exemplary embodiment, user devices 115 may be computers or computing devices that include a web browser or a software application, which enables user devices 115 to communicate with CA computer device 105 using the Internet, a local area network (LAN), or a wide area network (WAN). In some embodiments, the user devices 115 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User devices 115 may be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chatbots, voice bots, ChatGPT bots or ChatGPT-based bots, or other web-based connectable equipment or mobile devices.

A database server 305 may be communicatively coupled to a database 310 that stores data. In one embodiment, the database 310 may be a database that includes one or more large language models and/or interaction information. In some embodiments, the database 310 is stored remotely from the CA computer device 105. In some embodiments, the database 310 is decentralized. In the exemplary embodiment, a person may access the database 310 via the client devices by logging onto CA computer device 105.

Third-party servers 315 may be any third-party server that CA computer device 105 is in communication with that provides additional functionality and/or information to CA computer device 105. For example, third-party server 315 may host external LLM 110 (shown in FIG. 1) and/or may be an external data source 125 (shown in FIG. 1).

In the exemplary embodiment, third-party servers 315 may be computers that include a web browser or a software application, which enables third-party servers 315 to communicate with CA computer device 105 using the Internet, a local area network (LAN), or a wide area network (WAN). In some embodiments, the third-party server 315 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Third-party servers 315 may be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chatbots, voice bots, ChatGPT bots or ChatGPT-based bots, or other web-based connectable equipment or mobile devices.

In the exemplary embodiment, client devices 320 may be computers or computing devices that include a web browser or a software application, which enables client devices 320 to communicate with CA computer device 105 using the Internet, a local area network (LAN), or a wide area network (WAN). In some embodiments, the client devices 320 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Client devices 320 may be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chatbots, voice bots, ChatGPT bots or ChatGPT-based bots, or other web-based connectable equipment or mobile devices.

### Exemplary Server Device

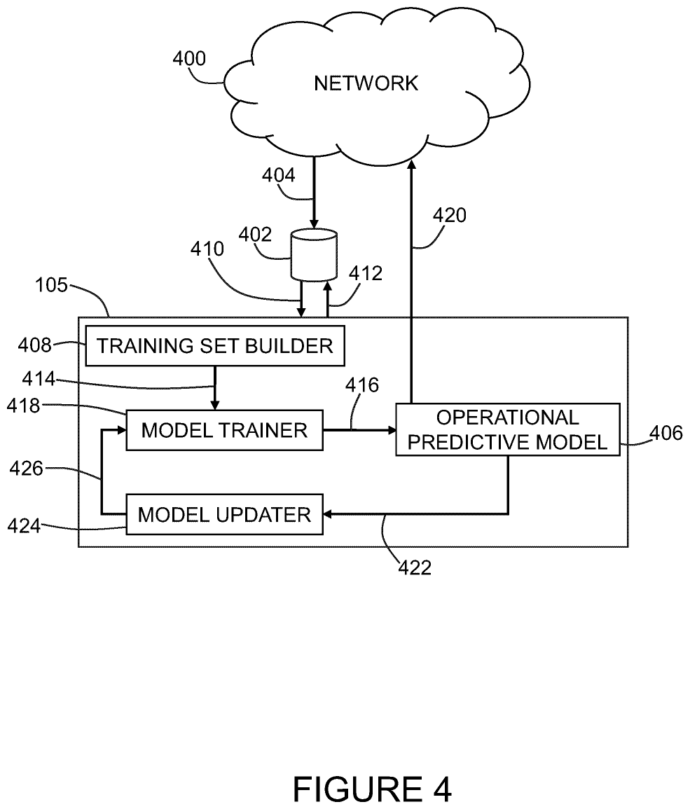

FIG. 4 is a schematic diagram of an exemplary conversation analysis (CA) server 105 (shown in FIG. 1), that may be used with the systems 100 and 300 (shown in FIGS. 1 and 3). CA server 105 may communicate with other components of system 300, such as third-party servers 315, client devices 320 (both shown in FIG. 3), user devices 115, internal data sources 120, external data sources 125, and/or LLMs 110 (all shown in FIG. 1), via a network 400.

CA server 105 may include and/or be in communication with a database 402 that stores data 404, such as database 310 (shown in FIG. 3), stored records generated by CA server 105, and/or any other relevant data s described herein. Data 404 received from network 400 may be stored in database 402. CA server 105 may configured to use data 404 to generate an operational large language model module 406 for controlling operations of CA server 105 (e.g., in accessing third-party databases via a digital portal), generating questions, timing, and language for requesting information from an individual 155, and the like.

In exemplary embodiments, CA server 105 may include a training set builder module 408 configured to submit one or more queries 410 to database 402 to retrieve subsets 412 of data 404, and to use those subsets 412 to build training data sets 414 for generating operational large language model 406. For example, query 410 may be configured to retrieve certain fields from data 404 for specific information, specific product, specific category, and/or any other division of factors desired by the user and/or for compliance, such as with a government entity.

In various embodiments, training set builder module 408 may be configured to derive training data sets 414 from retrieved subsets 412. Each training data set 414 corresponds to a historical data 404 (“historical” in this context means completed in the past, as opposed to completed in real-time with respect to the time of retrieval). Each training data set 414 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 414 may be generated from data fields in subset 412 corresponding to historical data 404. In other words, a trained machine learning model 416 produced by a model trainer module 418 for use by operational predictive model module 406 is trained to make predictions based upon input values that can be generated from the data fields in data 404. Values in the model input data fields may include values copied directly from values in a corresponding data field in the retrieved subset 412, and/or values generated by modifying, combining, or otherwise operating upon values in one or more data fields in the retrieved subset 412. The use of such data fields as model input data fields facilitates the machine learning model in weighing these factors directly.

After training set builder module 408 generates training data sets 414, training set builder module 408 passes the training data sets 414 to model trainer module 418. In certain embodiments, model trainer module 418 may be configured to apply the model input data fields of each training data set 414 as inputs to one or more machine learning models. Each of the one or more machine learning models may be programmed to produce, for each training data set 414, at least one output intended to correspond to, or “predict,” a value of the at least one result data field of the training data set 414. “Machine learning” refers broadly to various algorithms that may be used to train the model to identify and recognize patterns in existing data in order to facilitate making predictions for subsequent new input data.

Model trainer module 418 may be configured to compare, for each training data set 414, the at least one output of the model to the at least one result data field of the training data set 414, and apply a machine learning algorithm to adjust parameters of the model in order to reduce the difference or “error” between the at least one output and the corresponding at least one result data field. In this way, model trainer module 418 trains the machine learning model to accurately predict the value of the at least one result data field.

In other words, model trainer module 418 cycles the one or more machine learning models through the training data sets 414, causing adjustments in the model parameters, until the error between the at least one output and the at least one result data field falls below a suitable threshold, and then uploads at least one trained machine learning model 416 to operational large language model module 406 for application to generating recommendations 420. In exemplary embodiments, model trainer module 418 may be configured to simultaneously train multiple candidate machine learning models and to select the best performing candidate for each result data field, as measured by the “error” between the at least one output and the corresponding result data field, to upload to operational predictive model module 406.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 418 cycles through the training data sets 414, model trainer module 418 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 418 may provide an advantage by automatically discovering and properly weighting complex, second- or third-order, and/or otherwise nonlinear interconnections between the model input data fields and the at least one output. Absent the machine learning model, such connections are unexpected and/or undiscoverable by human analysts.

The CA server 105 of the present disclosure may be configured to operate on input data related to user interactions including analyzing past communications to determine effective communication methods with individuals to request information. In one exemplary embodiment, CA server 105 executes the operational large language model module 406 programmed to learn, without limitation, different techniques for communicating with individuals, individual preferences, details about the individuals, and how past communications with those individuals may affect future communications.

To facilitate this learning, CA server 105 may include one or more databases 402 at which the data, including data as well as responses, evidence, outcomes, etc., is stored. This data becomes one or more input training sets used by the training set builder module 408. Model outputs can be formatted for presentation or review as visual representations of recommendations, as text-based or natural language recommendations, and the like.

In exemplary embodiments, operational large language model module 406 may compare feedback, and may route a comparison result 422 generated by comparing recommendation 420 to the feedback to a model updater module 424 of CA server 105. Model updater module 424 is configured to derive a correction signal 426 from comparison results 422 received for one or more recommendations, and to provide correction signal 426 to model trainer module 418 to enable updating or “re-training” of the at least one machine learning model to improve performance. The retrained at least one machine learning model 416 may be periodically re-uploaded to operational large language model module 406.

### Exemplary Client Device

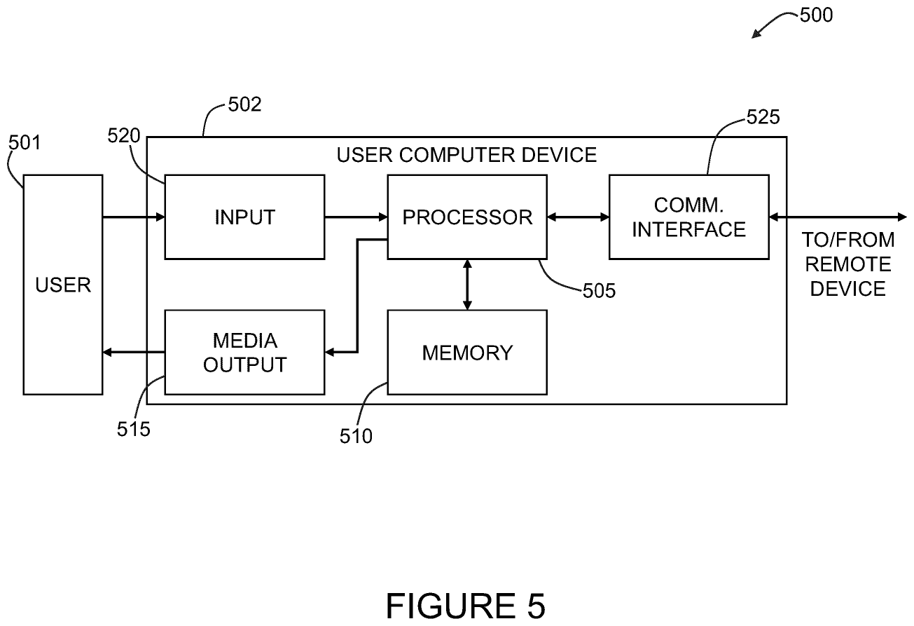

FIG. 5 depicts an exemplary configuration 500 of user computer device 502, in accordance with one embodiment of the present disclosure. In the exemplary embodiment, user computer device 502 may be similar to, or the same as, user device 115 (shown in FIG. 1) and client device 320 (shown in FIG. 3). User computer device 502 may be operated by a user 501.

User computer device 502 may include a processor 505 for executing instructions. In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501. A graphical user interface may include, for example, an interface for viewing items of information provided by the CA computer device 105 (shown in FIG. 1). In some embodiments, user computer device 502 may include an input device 520 for receiving input from user 501. User 501 may use input device 520 to, without limitation, provide information either through speech or typing.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as CA computer device 105. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from CA computer device 105. A client application may allow user 501 to interact with, for example, CA computer device 105. For example, instructions may be stored by a cloud service, and the output of the execution of the instructions sent to the media output component 515.

### Exemplary Server Device

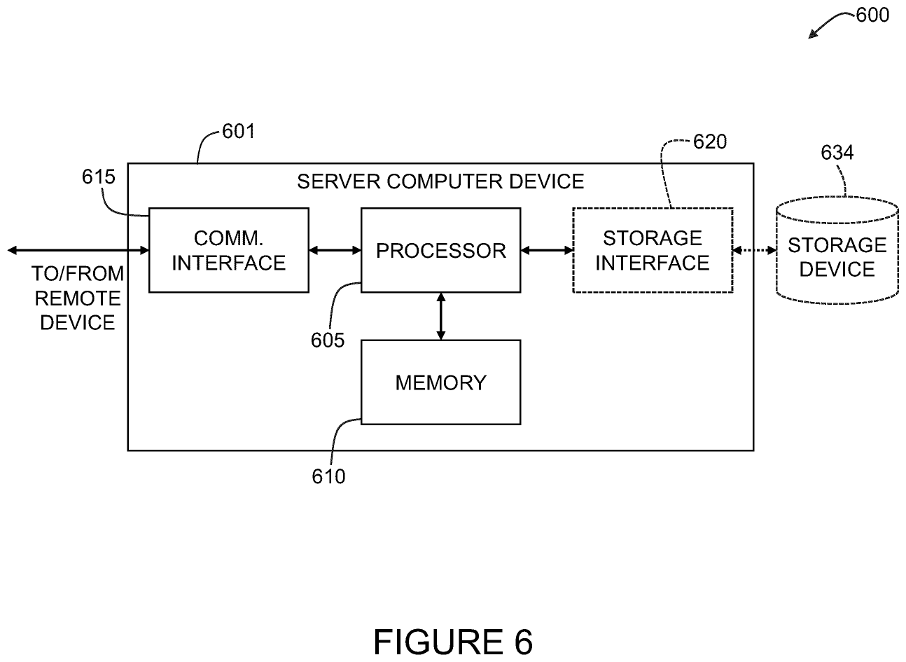

FIG. 6 depicts an exemplary configuration 600 of a server computer device 601, in accordance with one embodiment of the present disclosure. In the exemplary embodiment, server computer device 601 may be similar to, or the same as, CA computer device 105 (shown in FIG. 1), database server 305, and third-party server 315 (both shown in FIG. 3). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, CA computer device 105, third-party servers 315, and client devices (shown in FIG. 1) (for example, using wireless communication or data transmission over one or more radio links or digital communication channels). For example, communication interface 615 may audio input from client devices via the Internet, as illustrated in FIG. 3.

Processor 605 may also be operatively coupled to a storage device 634. Storage device 634 may be any computer-operated hardware suitable for storing and/or retrieving data, such as, but not limited to, data associated with one or more models. In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIG. 2.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, CA computer device 105 is configured to implement machine learning, such that CA computer device 105 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms.

In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In certain embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of images with known characteristics or features. Such information may include, for example, information associated with a plurality of images of a plurality of different objects, items, and/or property.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### EXEMPLARY EMBODIMENTS

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chatbots, ChatGPT bots, and/or other electronic or electrical components, which may be in wired or wireless communication with one another. For instance, the computer system may include at least one processor in communication with at least one memory device. The at least one processor may be configured to: (1) receive a request for information about a first individual; (2) retrieve information from one or more data sources based upon the request for information; (3) determine one or more missing items of information based upon the retrieved information and the request for information; (4) execute a GPT model trained with interaction data to generate one or more questions for the first individual to answer in order to provide the one of missing items of information; and/or (5) present the one or more questions to the first individual. The system may include additional, less, or alternate functionality, including that discussed elsewhere herein.

An enhancement of the system may include a processor configured to analyze the plurality of conversations. The conversations may be, for instance, retrieved from one or more memory units and/or acquired via one or more sensors, including microphones, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders.

A further enhancement of the system may include a processor configured to receive, from the first individual, one or more responses to the one or more questions. The system may further generate a response to the request for information based upon the retrieved information and the one or more responses to the one or more questions.

A further enhancement of the system may include a processor configured to determine a first channel to transmit the one or more questions to a computer device associated with the first individual.

A further enhancement of the system may include where the one or more questions includes a first question and a second question. The processor may be configured to determine a first channel to transmit the first question to a computer device associated with the first individual. The system may further determine a second channel to transmit the second question to a computer device associated with the first individual, wherein the first channel and the second channel are different.

A further enhancement of the system may include a processor configured to transmit the second question a period of time after the first question was answered. Additionally or alternatively, the system may include a processor configured to determine an order to ask the first question and the second question.

A further enhancement of the system may include a processor configured to train the GPT model with a plurality of interaction data with a plurality of individuals over a plurality of channels. The system may further include where the GPT model is trained with a plurality of interaction data associated with the first individual. The system may further include where the GPT model is executed with a plurality of interaction data associated with the first individual as input.

A further enhancement of the system may include a processor configured to generate the one or more questions via natural language processing.

In another aspect, a computer-implemented method may be provided. The computer-implemented method may be performed by a computer device including at least one processor in communication with at least one memory device. The method may include: (1) receiving a request for information about a first individual; (2) retrieving information from one or more data sources based upon the request for information; (3) determining one or more missing items of information based upon the retrieved information and the request for information; (4) executing a GPT model trained with interaction data to generate one or more questions for the first individual to answer in order to provide the one of missing items of information; and/or (5) presenting the one or more questions to the first individual. The computer-implemented method may include additional, less, or alternate actions, including those discussed elsewhere herein.

An enhancement of the method may include analyzing a plurality of conversations. The conversations may be, for instance, retrieved from one or more memory units and/or acquired via one or more sensors, including cameras, microphones, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders

An enhancement of the computer-implemented method may include receiving, from the first individual, one or more responses to the one or more questions. Additionally or alternatively, a further enhancement of the computer-implemented method may include generating a response to the request for information based upon the retrieved information and the one or more responses to the one or more questions.

An enhancement of the computer-implemented method may include determining a first channel to transmit the one or more questions to a computer device associated with the first individual.

An enhancement of the computer-implemented method may include where the one or more questions includes a first question and a second question. The method may also include determining a first channel to transmit the first question to a computer device associated with the first individual. Additionally or alternatively, a further enhancement of the computer-implemented method may include determining a second channel to transmit the second question to a computer device associated with the first individual, wherein the first channel and the second channel are different.

An enhancement of the computer-implemented method may include transmitting the second question a period of time after the first question was answered. Additionally or alternatively, the computer-implemented method may include determining an order to ask the first question and the second question.

An enhancement of the computer-implemented method may include training the GPT model with a plurality of interaction data with a plurality of individuals over a plurality of channels. Additionally or alternatively, a further enhancement of the computer-implemented method may include where the GPT model is trained with a plurality of interaction data associated with the first individual. Another enhancement may include where the GPT model is executed with a plurality of interaction data associated with the first individual as input.

An enhancement of the computer-implemented method may include generating the one or more questions via natural language processing.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) receive a request for information about a first individual; (2) retrieve information from one or more data sources based upon the request for information; (3) determine one or more missing items of information based upon the retrieved information and the request for information; (4) execute a GPT model trained with interaction data to generate one or more questions for the first individual to answer in order to provide the one of missing items of information; and/or (5) present the one or more questions to the first individual. The computer-executable instructions may direct additional, less, or alternate functionality, including that discussed elsewhere herein.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, NoSQL, IBM® DB2, Microsoft® SQL Server, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; and Microsoft is a registered trademark of Microsoft Corporation, Redmond, Washington.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for coordinating advanced communications, the system comprising at least one processor in communication with at least one memory device, the at least one processor programmed to:
receive a request for information about a first individual;
retrieve information from one or more data sources based upon the request for information;
determine one or more missing items of information based upon the retrieved information and the request for information;
execute a GPT model trained with interaction data to generate one or more questions for the first individual to answer in order to provide the one or more missing items of information; and
present the one or more questions to the first individual.

2. The computer system of claim 1, wherein the at least one processor is further programmed to receive, from the first individual, one or more responses to the one or more questions.

3. The computer system of claim 2, wherein the at least one processor is further programmed to generate a response to the request for information based upon the retrieved information and the one or more responses to the one or more questions.

4. The computer system of claim 1, wherein the at least one processor is further programmed to determine a first channel of communication to transmit the one or more questions to a computer device associated with the first individual.

5. The computer system of claim 1, wherein the one or more questions includes a first question and a second question, and wherein the at least one processor is further programmed to:
determine a first channel of communication to transmit the first question to a computer device associated with the first individual; and
determine a second channel of communication to transmit the second question to a computer device associated with the first individual, wherein the first channel and the second channel are different.

6. The computer system of claim 5, wherein the at least one processor is further programmed to transmit the second question a period of time after the first question was answered.

7. The computer system of claim 5, wherein the at least one processor is further programmed to determine an ordering for communicating the first question and the second question.

8. The computer system of claim 1, wherein the at least one processor is further programmed to train the GPT model with a plurality of interaction data associated with a plurality of individuals over a plurality of channels of communication.

9. The computer system of claim 8, wherein the GPT model is trained with the plurality of interaction data associated with the first individual.

10. The computer system of claim 8, wherein the GPT model is executed with the plurality of interaction data associated with the first individual as input.

11. The computer system of claim 1, wherein the at least one processor is further programmed to generate the one or more questions via natural language processing.

12. A computer-implemented method for coordinating advanced communications implemented by a computer system including at least one processor in communication with at least one memory device, the method comprising:
receiving a request for information about a first individual;
retrieving information from one or more data sources based upon the request for information;
determining one or more missing items of information based upon the retrieved information and the request for information;
executing a GPT model trained with interaction data to generate one or more questions for the first individual to answer in order to provide the one or more missing items of information; and
presenting the one or more questions to the first individual.

13. The computer-implemented method of claim 12 further comprising receiving, from the first individual, one or more responses to the one or more questions.

14. The computer-implemented method of claim 12 further comprising generating a response to the request for information based upon the retrieved information and the one or more responses to the one or more questions.

15. The computer-implemented method of claim 12 further comprising determining a first channel of communication to transmit the one or more questions to a computer device associated with the first individual.

16. The computer-implemented method of claim 12, wherein the one or more questions includes a first question and a second question, and wherein the method further comprises:
determining a first channel of communication to transmit the first question to a computer device associated with the first individual; and
determining a second channel of communication to transmit the second question to a computer device associated with the first individual, wherein the first channel and the second channel are different.

17. The computer-implemented method of claim 16 further comprising transmitting the second question a period of time after the first question was answered.

18. The computer-implemented method of claim 16 further comprising determining an ordering and a sentence structure for presenting the first question and the second question to the first individual.

19. The computer-implemented method of claim 12 further comprising training the GPT model with a plurality of interaction data associated with a plurality of individuals over a plurality of channels of communication.

20. The computer-implemented method of claim 19, wherein the GPT model is trained with the plurality of interaction data associated with the first individual.

21. The computer-implemented method of claim 19, wherein the GPT model is executed with the plurality of interaction data associated with the first individual as input.

22. The computer-implemented method of claim 12 further comprising generating the one or more questions via natural language processing wherein the GPT model generates the one or more questions using language and a communication channel that are preferred by the first individual.

23. At least one non-transitory computer-readable storage media having computer-executable instructions embodied thereon, wherein when executed by at least one processor of a computer system, the computer-executable instructions cause the processor to:
receive a request for information about a first individual;
retrieve information from one or more data sources based upon the request for information;
determine one or more missing items of information based upon the retrieved information and the request for information;
execute a GPT model trained with interaction data to generate one or more questions for the first individual to answer in order to provide the one of missing items of information; and
present the one or more questions to the first individual.
